(19) United States
(12) Patent Application Publication
(10) Pub. No.: US 2026/0359193 A1
(43) Pub. Date: Nov. 12, 2026

(54) MACHINE LEARNING AUTOMATED PIPELINE FAILURE DETERMINATION SYSTEM

(71) Applicant: eBay inc., SanJose, CA (US)

(72) Inventors: Jipeng Chen, Seattle, WA (US); Milan Chen, San Jose, CA (US); Nischith Bedachuvaly Nataraja, San Jose, CA (US); Piyush Dubey, San Jose, CA (US)

(21) Appl. No.: 19/200,071

(22) Filed: May 6, 2025

(51) Int. Cl. G06F 11/3604; G06F 11/3668

(52) U.S. Cl. CPC G06F 11/3608; G06F 11/3688; G06F 11/3692

(57) ABSTRACT

Systems and methods are directed to machine learning (ML) automated pipeline failure determination. A training system groups previous pipeline runs into a dataset by corresponding identifiers. The dataset is processed through a training pipeline that includes labeling, using an automated labeling algorithm, failed pipeline runs in the dataset with an indication to retry or not to retry, whereby the indication to retry is associated with a failure based on a random reason of the infrastructure. The training system trains a ML model with training data from the processed dataset. Subsequently, an inference system receives a request comprising information regarding a new failed pipeline run. The inference system determines a probability of the new failed pipeline run being caused by a random reason by applying the information to the ML model. Based on the probability transgressing a threshold, the inference system automatically triggers a retry of the new failed pipeline run.

### TECHNICAL FIELD

The subject matter disclosed herein generally relates to software development. Specifically, the present disclosure addresses systems and methods that use machine learning to automate determination of whether a pipeline failure occurred for a random reason of an infrastructure and, in some cases, to trigger an automatic pipeline retry.

### BACKGROUND

In software development, the process of creating, testing, and deploying applications is often organized into a structured software development pipeline. A continuous delivery (CD) pipeline is a specific type of software development pipeline that emphasizes automation and rapid deployment. The primary goal of the CD pipeline is to ensure that software can be released to users quickly and with minimal manual intervention.

Despite their advantages, a CD pipeline can experience failures at various stages, disrupting the software delivery process. Some causes of CD pipeline failure include a build failure, a test failure, deployment issues, infrastructure instability, or just randomness. When a pipeline failure occurs, a developer often needs to figure out what went wrong and perform manual retries to resolve the issue. These manual retries are prone to human errors and inconsistencies as well as requiring additional time and effort of developers, which slows down delivery of the software and increases use of computational resources.

### BRIEF DESCRIPTION OF THE DRAWINGS

FIG. 1 is a diagram illustrating an example network environment suitable for using machine learning to automate determination of whether a pipeline failure occurred for a random reason of an infrastructure, according to example embodiments.

FIG. 2 is a diagram illustrating components of a pipeline training system, according to example embodiments.

FIG. 3 is a diagram illustrating an example data flow within a model architecture, according to example embodiments.

FIG. 4 is a diagram illustrating an example data flow within a system architecture, according to example embodiments.

FIG. 5 is a diagram illustrating an example data flow within an alternative system architecture, according to example embodiments.

FIG. 6 is a flowchart of a method for training a machine learning model used to determine whether a pipeline failure occurred for a random reason of the infrastructure, according to example embodiment.

FIG. 7 is a flowchart of a method for determining whether a pipeline failure occurred for a random reason of the infrastructure and triggering a pipeline retry, according to example embodiments.

FIG. 8 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Systems and methods that use machine learning (ML) to determine whether a pipeline failure occurred for a random reason of the infrastructure and to trigger a pipeline retry are discussed herein. In continuous delivery systems, such as enterprise continuous delivery (ECD) system, every time a developer makes a change to code, it can be deployed into production (e.g., into a website). However, there can be many failures during this process. The failures can include test failures, deployment failure (e.g. delivery pipeline fails), build failures (e.g., an error in the code), or be based on an issue with the entire system. Sometimes, the failure is purely random. This can be a result of the fact that the infrastructure can be very large and can just randomly fail.

A pipeline run comprises execution of a series of automated processes within the continuous delivery system or pipeline that transforms code changes into deployable software artifacts. These software artifacts are ultimately delivered to a production system or environment. A pipeline run is typically initiated by a trigger event, such as a new code commit. During the pipeline run, the build system compiles the source code into executable programs or libraries (e.g., software artifacts) and can include a testing stage. The software artifacts can then be deployed. A pipeline failure can occur at any stage of the pipeline run.

Typically, when there is a failure in the pipeline, manual review is often required to determine what caused the failure-whether the failure is due to a code change that was made (e.g., human error) or because of a random reason from the infrastructure (e.g., infrastructure instability). However, this manual process can be time consuming and resource intensive. It can also be a waste of resources if the failure was due to randomness (e.g., due to random integration test errors or random deployment issues) and not due to code errors.

Example embodiments provide a technical solution that creates and refines a machine learning (ML) model that predicts whether a new failed pipeline run was a result of an infrastructure issue/random reason and not a code issue. The training of the ML model includes labeling, by an automated labeling algorithm, previous pipeline runs with either an indication that the pipeline failure was an infrastructure issue or not. The labeling is performed automatically without any human intervention. In some embodiments, the indication that the pipeline failure was an infrastructure issue comprises an indication to retry the pipeline run, while the indication that the pipeline failure was not an infrastructure issue (e.g., was a code issue) comprises an indication to not retry the pipeline run. As new data from pipeline runs become available, the ML model is retrained to improve its predictions.

When a new pipeline run fails, information regarding the new failed pipeline run is applied to the trained ML model. The ML model determines a probability that the new failed pipeline run was because on an infrastructure issue/random reason. If the probability transgresses a threshold, a retry of the new failed pipeline run can automatically be triggered without human intervention.

As an example, assume a system performs 62,334 pipeline runs to deliver updates across 216 applications and that 35,264 of these attempts results in a pipeline failure. Assume further that 11,808 occurrences of the pipeline failures are a result of a random reason or intermittent glitches. The system can trigger a retry for these occurrences without necessitating developer intervention and thereby save computer resources and developer tool resources. Conversely, 23,456 failures should not be retried (e.g., potentially saving further computational resources) but investigated. On average, every failed pipeline takes 86 minutes, and the failed stage takes 20 minutes. Assuming every pipeline failure is retried twice, that means ⅔ of the pipeline failures that should not be retried are retried twice. Thus, 20*2*2/3=27 minutes of lead time can be wasted while waiting on the retries that will still fail, as well as wasting computational resources required to perform these failed retries.

The use of the ML model trained with training data automatically labeled by the automated labeling algorithm provides a technical solution that is an improvement to conventional systems that either retry or investigate all failed pipeline runs. By automatically labeling previously failed pipeline runs with either an indication that the pipeline run failure was random or not, this labeled data can be used to train the ML model that determines a probability that a future failed pipeline run was because on a random reason and whether it should be automatically retried. As a result, example embodiments provide a technical solution that uses machine learning to automate continuous delivery pipeline decision making.

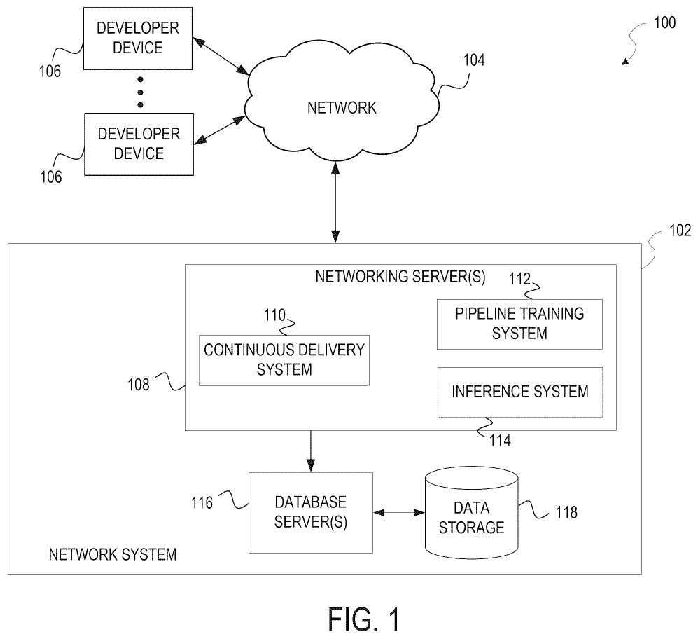

FIG. 1 is a diagram illustrating an example network environment suitable for using machine learning (ML) to automate determination of whether a pipeline failure occurred for a random reason of an infrastructure, according to example embodiments. A network system 102 provides server-side functionality via a communication network 104 (e.g., the Internet, wireless network, cellular network, or a Wide Area Network (WAN)) to a plurality of developer devices 106. The network system 102 is configured to train a ML model that predicts whether a pipeline failure was based on an infrastructure issue/random reason and to trigger automatic retry when a probability that the pipeline failure was based on an infrastructure issue/random reason transgresses a threshold, as will be discussed in more detail below.

In example embodiments, each developer device 106 is a device associated with a developer or engineer that develops software code to be deployed in the network system 102. The developer device 106 can comprise, but is not limited to, a smartphone, a tablet, a laptop, multi-processor systems, microprocessor-based or programmable consumer electronics, a desktop computer, a server, or any other communication device that can access the network system 102.

In example implementations, the developer device 106 interfaces with the network system 102 via a connection with the network 104. Depending on the form of the developer device 106, any of a variety of types of connections and networks 104 may be used. For example, the connection may be Code Division Multiple Access (CDMA) connection, a Global System for Mobile communications (GSM) connection, or another type of cellular connection. When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (e.g., Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

Turning specifically to the network system 102, the network system 102 comprises one or more networking servers 108 that receives instructions, code, and requests from the developer devices 106 and processes that data. The networking servers 108 host various systems including a continuous delivery system 110, a pipeline training system 112, and an inference system 114, each comprising a plurality of components and each of which can be embodied as a combination of hardware, software, and/or firmware. The networking servers 108 can comprise other system based on the nature of the network system 102. Further still, some of the systems can be combined into a single system.

The continuous delivery system 110 is configured to build, test, and deploy software, enabling developers at the developer devices 106 to deliver new code (e.g., features and updates) quickly. The continuous delivery system 110 passes changes through a rigorous pipeline of stages, including automated builds, testing, and deployment preparation. As such the continuous delivery system 100 includes a build component and a deployment component.

The build component transforms (e.g., complies) source code received from the developer devices 106 into deployable software artifacts. A build process is typically triggered automatically whenever new code changes are committed to a version control system of the continuous delivery system 110. The build component compiles the source code into executable programs or libraries by translating the code into machine-readable formats. Once compiled (and tested), the deployable product is eventually provided to a deployment or production component.

The production component is a final stage of a continuous delivery pipeline where the software is deployed and made available to end users. The production component ensures that the software operates reliably and efficiently in a real-world environment. In example embodiments, the production component relies on automated deployment processes to ensure that software updates are delivered consistently and with minimal manual intervention.

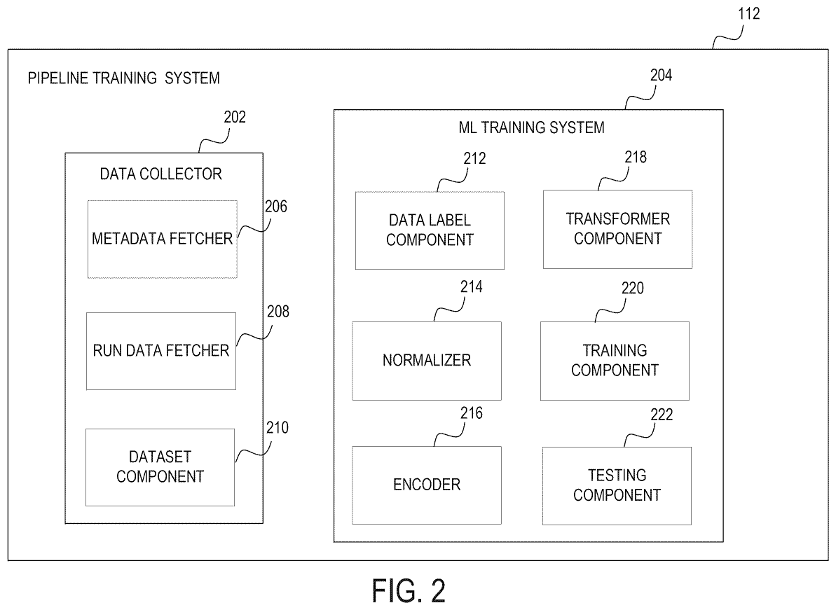

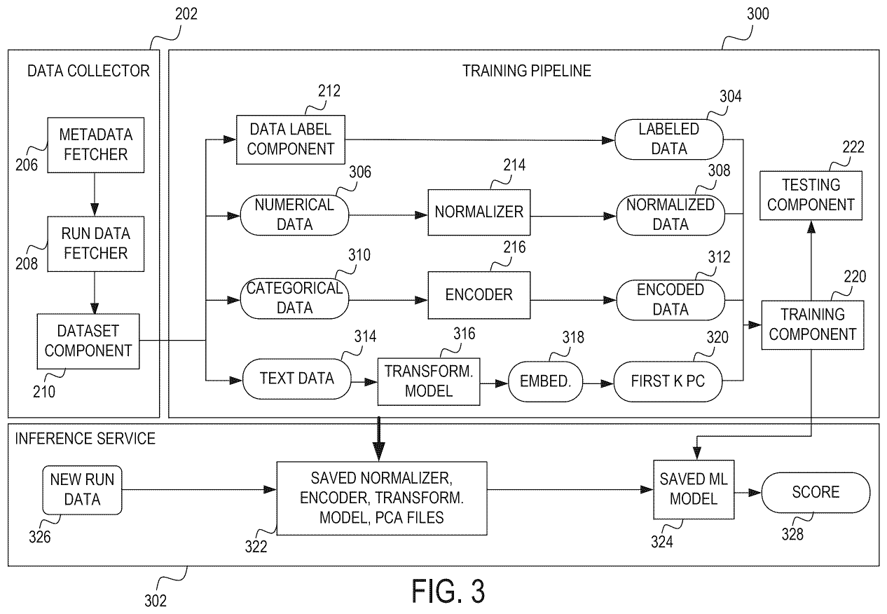

The pipeline training system 112 is configured to training a machine learning (ML) model that predicts whether a pipeline failure is based on an infrastructure issue (e.g., a random reason of the infrastructure). The pipeline training system 112 will be discussed in more detail in connection with FIG. 2 and FIG. 3 below.

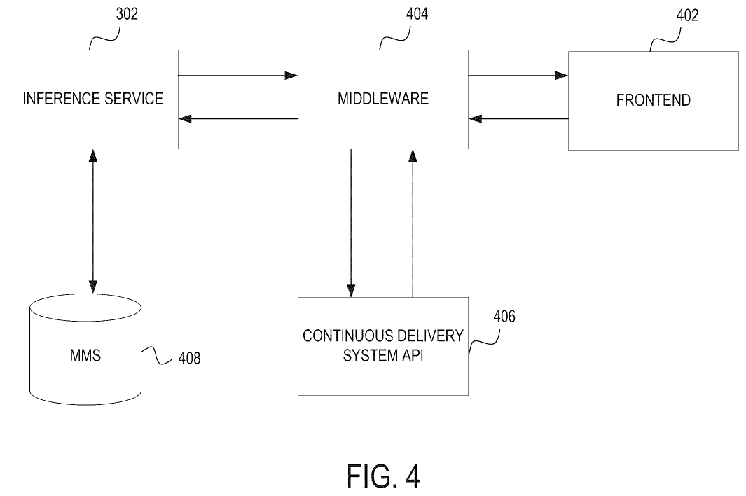

The inference system 114 is configured to use the ML model from the pipeline training system 112 to infer whether a new pipeline failure is based on a random reason of the infrastructure. In some embodiments, the inference system 114 triggers an automatic, without any human intervention, retry of a new failed pipeline run if the pipeline run likely failed due to an infrastructure issue or random reason. The inference system 116 will be discussed in more detail in connection with FIG. 3 and FIG. 4 below.

The networking servers 108 can be, in turn, coupled to one or more database servers 116 that facilitate access to one or more storage repositories or data storage 118. The data storage 118 is a storage device storing, for example, software code associated with the network system 102.

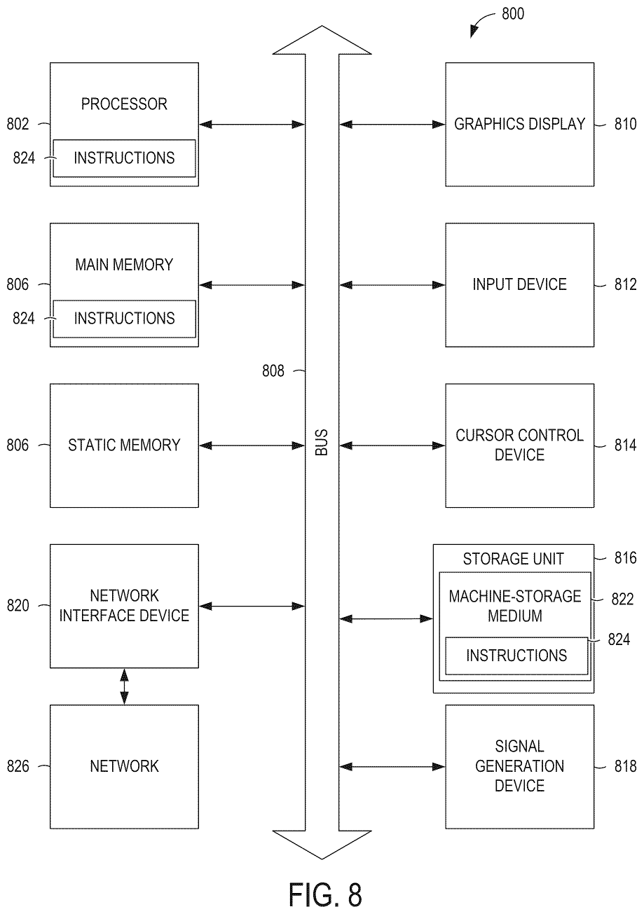

Any of the systems, services, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 8, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 can be combined and/or the functions described herein for any single component can be subdivided among multiple components. Functionalities of one component can, in alternative examples, be embodied in a different component. Additionally, any number of developer devices 106 can be embodied within the network environment 100. While only a single network system 102 is shown, alternatively, more than one network system 102 can be included (e.g., localized to a particular region).

FIG. 2 is a diagram illustrating components of the pipeline training system 112, according to example embodiments. In example embodiments, the pipeline training system 112 comprises one or more servers that manages the training and retraining of the ML model used to predict whether a pipeline failure is due to an infrastructure issue or random reason or not (e.g., due to a code error or issue). To enable these operations, the pipeline training system 112 comprises a data collector 202 and a ML training system 204.

The data collector 202 is configured to aggregate past pipeline run information. As such, the data collector 202 comprises a metadata fetcher 206, a (pipeline) run data fetcher 208, and a dataset component 210. In example embodiments, a plurality of applications are being managed by the continuous delivery system 110. In some embodiments, the applications are contained in configuration files. There is also a file containing all application names. In some embodiments, the metadata fetcher 206 calls an application programming interface (API) of the continuous delivery system 110 to fetch all metadata for these applications based on that file. The run data fetcher 208 is configured to fetch all detailed pipeline raw data that have not been previously processed. This includes all previous, historical pipeline runs for a predetermine amount of time (e.g., last six months).

The dataset component 210 processes the fetched data into a training dataset. In some embodiments, the dataset component 210 generates a coma separated values (CSV) file of training data. The dataset component 210 then feeds the training dataset to the ML training system 204.

The ML training system 204 is configured to perform the training of the ML model. To enable the training of the ML model, the ML training system 204 comprises a data label component 212, a normalizer 214, an encoder 216, a transformer component 218, a training component 220, and a testing component 222.

The data label component 212 is configured to label pipeline runs in an automated manner without any human intervention. In example embodiments, the data label component 212 receives the training dataset and groups pipeline runs by their corresponding manifest identifier or commit number. The data label component 212 then preprocesses the data by filtering out certain data points such as manifests that only have a single pipeline run. Next, the data label component 212 labels all failed pipeline runs as either being based on an infrastructure issue/random reason or not. In some embodiments, the data label component 212 initially labels all failed pipeline runs as “should not retry” or with an indication that the failure was not due to a random reason. The data label component 212 then relabels failed pipelines as “should try” (or simply “retry”) or with an indication that the failure was for a random reason (or because of an infrastructure issue) if the failed pipeline has a final pipeline run that is successful without human involvement in the process (e.g., no recoding) or if the pipeline failure was otherwise due to a random reason not code related.

By observing the history of the previous delivery pipelines, the data label component 212 can automatically generate substantial labeled data on whether a failure is because of a random reason or because of code changes. The history comprises logs of previous pipeline runs with manual retries. In labeling the failed pipeline, the data label component 212 analyzes the history of pipeline runs that have a same commit number and/or manifest identifier. If a first pipeline run (or first several pipeline runs) failed, but the final pipeline run was successful, this indicates that the first pipeline run (or first several pipeline runs) failed because of a random reason. The random reason can be anything other than a problem with the code (e.g., a random reason in the infrastructure). In this situation, the data label component 212 labels all the previous pipeline runs as a random failure and/or with an indication to retry. As such, the labeling is performed in an automated manned by the data label component 212 without any human intervention.

In example embodiments, features of the training data is divided into three types of features: numerical data (e.g., how long did a pipeline run), categorical data (e.g., category/stage of the failure), and text data (e.g., committing information of the code, failure message returned by infrastructure). Each feature type is processed by a different component of the ML training system 204.

In example embodiments, the normalizer 214 comprises a fitted normalizer that processes the numerical data. The different pipeline runs can have numerical data with different ranges. For example, some data can have a range from 1 to 100, while other data have a range from 1 to 1 million. The normalizer 214 normalizes the numerical data. In one embodiment, the numerical data is normalized to a range of 0 to 1.

Categorical data indicates where in the pipeline the pipeline run failed. It can occur at several stages such as, for example, a build stage, a testing stage, or a deployment stage. The encoder 216 converts the stage to a numerical representation that a machine can understand.

Textual data can comprise various data that a machine directly cannot understand. This data can include, for example, committing information of the code and failure messages. The transformer component 218 converts this textual data into an array of numbers that the machine can understand. In one embodiment, the transformer component 218 comprises a transformer model such as a BERT model (Bidirectional Encoder Representations from Transformers) that is further trained with a large number of expression-enriched exercises to result in an expression-enriched BERT model (referred to as “eBERT”). Because the array generated by the transformer model is 768 dimensions, principal component analysis (PCA) can be applied to extract the most important dimensions (e.g., first K principal components).

The training component 220 is configured to train the ML model. In example embodiments, the training component 220 receives the labeled data from the data label component 212, the normalized numerical data from normalizer 214, the encoded categorical data from the encoder 116, and/or the transformed text data from the transformer component 218. The training component 220 uses the data it receives to train the ML model. It is noted that the training component 220 only needs the labeled data to perform the training. The addition of one or more of the normalized numerical data, the encoded categorical data, and/or the transformed text data in training the ML model is supplementary. In one embodiment, the training component 220 comprise an Extreme Gradient Boost (XGBoost). However, other gradient boosting components or machine learning models can be used.

The testing component 222 is configured to test the training process and tuning of the ML model. In some embodiments, the testing component 222 determines an accuracy and AUC (Area Under the Curve) score to measure the quality of the ML model.

FIG. 3 is a diagram illustrating an example data flow within a model architecture, according to example embodiments. The model architecture comprises a training pipeline 300 that includes the components of the ML training system 204 communicatively coupled to the components of the data collector 202 and an inference service 302 (e.g., the inference system 114).

Initially, the components of the data collector 202 access data to be used in training the ML model. As such, the metadata fetcher 206 calls an API of the continuous delivery system 110 to fetch all metadata for applications managed by the continuous delivery system 110. Additionally, the run data fetcher 208 fetches all new detailed pipeline raw data including previous, historical pipeline runs for a predetermine amount of time. The dataset component 210 then processes the fetched metadata and pipeline raw data into a training dataset. In some embodiments, the dataset component 210 generates a CSV file of training data.

The training dataset is then fed into the training pipeline 300 by the dataset component 212. The training dataset is provided to the data label component 212 and processed by various feature processing components of the ML training system 204.

The data label component 212 labels the failed pipeline runs in an automated manner without human intervention. In example embodiments, the data label component 212 groups pipeline runs by their corresponding manifest identifier and/or commit number. The data label component 212 then preprocesses the data by filtering out certain data points such as manifests that only have a single pipeline run. Next, the data label component 212 labels all failed pipeline runs as either being based on a random reason (e.g., of the infrastructure) or not. In some embodiments, the data label component 212 initially labels all failed pipeline runs as “not random” or “should not retry”. The data label component 212 then relabels failed pipelines as “random” or “should retry” (or simply “retry”) if the failed pipeline has a final pipeline run that is successful without human involvement (e.g. no code fix) or was due to a random reason. The result is labeled data 304, which can be including in the training dataset used by the training component 220.

The features of the training dataset are processed, in parallel, by different components of the ML training system 204. In example embodiments, numerical data 306 is processed through the normalizer 214. The normalizer 214 can comprise a fitted normalizer that normalizes the numerical data to generate normalized data 308 within a particular data range. In one embodiment, the numerical data is normalized to a range of 0 to 1.

Categorical data 310 indicates a stage of the pipeline in which a pipeline run failed. The categorical data 310 is processed through the encoder 216 which converts the categorical data 310 into encoded data 312. The encoded data 312 comprises a numerical representation that is understood by a machine.

Textual data (text data 314) can include, for example, committing information of the code and failure messages. The text data 314 is processed by the transformer component 218 which includes a transform model 316 that converts the text data 314 into a numerical array or embedding 318. In one embodiment, the transformer model 316 comprises an expression-enriched BERT model (eBERT). Alternative embodiments can use other types of transformer models. Because the embedding 318 generated by the transformer model 316 can be 768 dimensions, principal component analysis (PCA) can be applied by the transformer component 218 to extract the most important dimensions or first K principal components 320.

In some embodiments, the normalized data 308, the encoded data 312, and the embeddings 318 and/or first K principal components 320 are included in the training dataset used by the training component 220. In other embodiments, none of the normalized data 308, the encoded data 312, and the embeddings 308 and/or first K principal components 320 are used (e.g., not included in the training dataset) or only one or two of the normalized data 308, the encoded data 312, or the embeddings 308 and/or first K principal components 320 are used. That is, the training data with labels is mandatory but the rest of the data are supplementary information which can be used but not required.

In example embodiments and prior to training, the training dataset is randomly split into three parts. The first part is training data that is provided to the training component 220 and used to train the ML model. The training component 220 trains (e.g., using XG Boost) a ML model that can predict (e.g., provide a probability) whether a new failed pipeline run was a result of a random reason or not (e.g., because of a code issue). In some embodiments, the prediction indicates whether to retry (e.g., based on a random reason) or not retry (e.g., based on a non-random reason).

The second part is a validation dataset which is used to tune one or more parameters of the training component 220 (e.g., XE boost model). As an example, the validation dataset can be used to tune a max depth of the ML model (e.g., to find the right balance between bias and variance for optimal performance).

The third part is a test dataset which is provided to the testing component 222 and used to test the process of training and tuning the ML model. In example embodiments, the test dataset is fed into the ML model to obtain a prediction. The prediction is then compared to the dataset with the labels that was used for the testing. Thus, the testing component 322 can determine an accuracy or AUC (Area Under the Curve) score to measure the quality of the ML model.

In the training pipeline 300, a plurality of files are generated. These include the files generated by the normalizer 214, the encoder 216, the transform model 316, and from the principal component analysis. These files can be uploaded to the inference service 302 (e.g., saved files 322) and/or stored to a model management system. Additionally, the ML model can be uploaded (e.g., save ML model 324) to the inference service 302 and/or stored to the model management system. For example, when new pipeline run data 326 indicating a pipeline failure on the continuous delivery system 110 is received, the files and the ML model are uploaded (or accessed) by the inference service 302. The files and ML model are then used to predict whether the new pipeline failure is because of a random reason in the infrastructure or failed because of a code issue. In some embodiments, the prediction can be a score 328 or probability. In other embodiments, the prediction can be a yes (based on a random reason) or no (based on a code issue) or other similar types of results.

FIG. 4 is a diagram illustrating an example data flow within a system architecture, according to example embodiments. A frontend 402 is associated with a user (e.g., a developer) of the network system 102. A request from the frontend 402 is sent to middleware 404. The request can include an identifier of a failed pipeline run (e.g., pipelineRun_id”: “123”).

Once the middleware 404 receives the identifier, the middleware 404 calls a continuous delivery system API 406. The continuous delivery system API 406 fetches all the information (e.g., metadata, features) regarding the pipeline run and returns it to the middleware 404. The fetched information can include, for example, a duration of the pipeline run, which phase/stage the pipeline failed, and/or a failure time. The middleware 404 subsequently composes a request with the fetched information and sends it to the inference service 302 (e.g., the inference system 114). In some embodiments, the request can include an indication to perform automatic retry if a prediction (e.g., score) transgresses a threshold.

The files and the ML model from the training pipeline 300 are loaded to a model management system (MMS) 408. When the inference service 302 receives the request, the inference service 302 accesses the files and the ML model at the MMS 408. The information that was fetch is then applied to the files and the ML model to perform the prediction. Once the prediction is obtained, the inference service 302 sends the prediction back to the frontend 402 through the middleware 404. In some cases, the prediction comprises an indication of whether the pipeline run failure was likely a result of a random reason (and/or should be retried) or a code issue (and/or should not be retried). In some cases, a score or probability is returned to the frontend 402.

In some embodiments, if the prediction indicates a probability or score that transgresses a threshold, the pipeline run can be automatically retried. In these embodiments, the inference service 302 triggers the continuous delivery system 110 to retry the pipeline run. For example, if the probability is greater the 0.50, the pipeline run will be retried.

While the embodiment of FIG. 4 includes the middleware 404, alternative embodiments may remove the middleware 404. In these embodiments, the frontend 402 communicates directly with the inference service 302 and the inference service 302 obtains all the information (e.g., metadata, features) regarding the pipeline run from the continuous delivery system (e.g., via the continuous delivery system API 406).

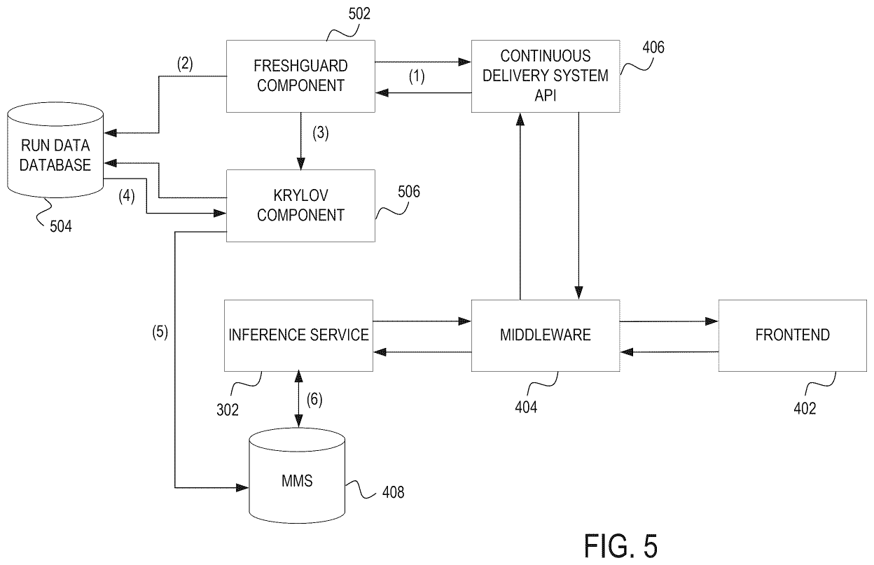

FIG. 5 is a diagram illustrating an example data flow within an alternative system architecture, according to example embodiments. The embodiment of FIG. 5 is an extension of the embodiment of FIG. 4. This embodiment attempts to keep the ML model “fresh” such that the ML model is current with latest changes. As such, the embodiment of FIG. 5 includes a freshguard component 502. In example embodiments, the freshguard component 502 comprises a service that regularly fetches (1) data from the continuous delivery system API 406 directly. The fetched data is then stored (2) to a run data database 504.

The freshguard component 502 monitors how much of the run data has not been incorporated into training of the ML model. If the unused run data is aggregated over a limit (e.g., 100,000 run data) and/or when a predetermined period of time is reached (e.g., every three months), the freshguard component 502 triggers (3) a Krylov component 506 training pipeline. In some embodiments, the freshguard component 502 causes an API on the Krylov component 506 to retrain the ML model. Thus, the Krylov component 506 pulls (4) the unused run data from the run data database 504. Once done training, the Krylov component 506 pushes (5) the new ML model to the MMS 408. As such, the inference service 302 is kept fresh by using (6) the latest ML model.

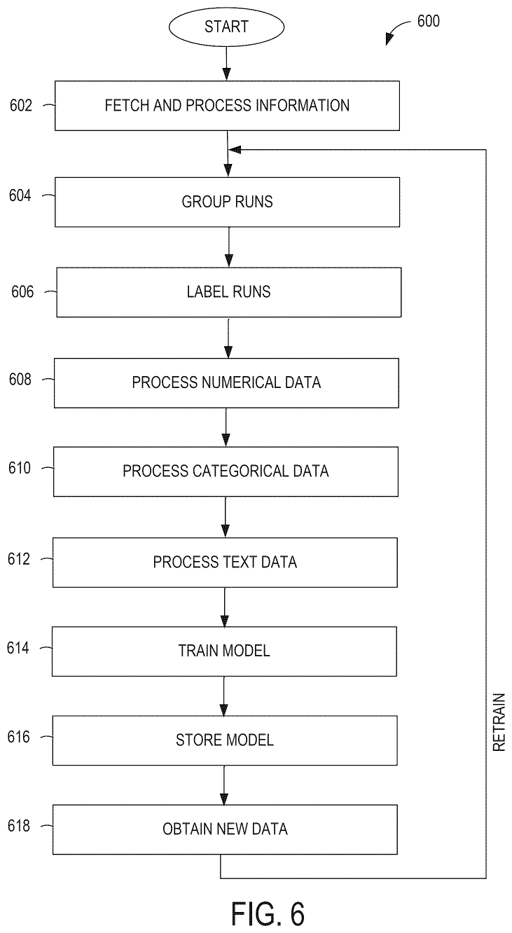

FIG. 6 is a flowchart of a method 600 for training a machine learning model used to determine whether a pipeline failure occurred for a random reason of the infrastructure, according to example embodiment. Operations in the method 600 may be performed by the pipeline training system 112 described above with respect to FIG. 2 and FIG. 3. Accordingly, the method 600 is described by way of example with reference to the pipeline training system 112. However, it shall be appreciated that at least some of the operations of the method 600 may be deployed on various other hardware configurations or be performed by similar components residing elsewhere in the network environment 100. Therefore, the method 600 is not intended to be limited to the pipeline training system 112.

In operation 602, components of the data collector 202 fetch past pipeline run information and process the information. In example embodiments, the metadata fetcher 206 calls an application programming interface (API) of the continuous delivery system 110 to fetch metadata for applications managed by the continuous delivery system 110. Additionally, the run data fetcher 208 fetches all detailed pipeline raw data including previous, historical pipeline runs for a predetermine amount of time. Finally, the dataset component 210 processes the fetched data into a training dataset. In some embodiments, the dataset component 210 generates a CSV file of training data that is provided to the ML training system 204.

In operation 604, the data label component 212 groups the pipeline runs. In example embodiments, the data label component 212 receives the training dataset from the dataset component 210 and groups pipeline runs by their corresponding manifest identifier and/or commit number. In some cases, the data label component 212 preprocesses the dataset by filtering out certain data points such as manifests that only have a single pipeline run.

In operation 606, the data label component 212 labels the pipeline runs. In example embodiments, the data label component 212 labels all failed pipeline runs as either being based on a random reason (e.g., of the infrastructure) or not (e.g., based on a code issue). In some embodiments, the data label component 212 initially labels all failed pipeline runs as “not random” or “should not retry”. The data label component 212 then relabels failed pipelines as “random” or “should retry” (or simply “retry”) if the failed pipeline has a final pipeline run that is successful without human involvement (e.g. no code fix) or was due to a random reason. It is noted that other labels can be used to indicate a pipeline run that failed due to a non-code issue or random reason versus a pipeline run that failed due to a code issue. Further still, the pipeline runs can be labeled with an indication of where they failed.

In operation 608, the normalizer 214 processes numerical data from the training dataset. The numerical data can comprise, for example, how long a pipeline run was. In example embodiments, the normalizer 214 can comprise a fitted normalizer that normalizes the numerical data to a particular data range. In one embodiment, the numerical data is normalized to a range of 0 to 1.

In operation 610, the encoder 216 processes categorical data from the training dataset. The categorical data can comprise, for example, a category or stage where the pipeline failure occurred. In example embodiments, the encoder 216 converts the categorical data into encoded data that comprises a numerical representation of the categorical data.

In operation 612, the transformer component 218 processes the text data. The text data can comprise, for example, committing information of the code or a failure message returned by the infrastructure. In example embodiments, the transform model 316 of the transformer component 218 converts the text data into a numerical array or embedding. Because the embedding can be dimensionally large (e.g., 768 dimensions), principal component analysis (PCA) can be applied by the transformer component 218 to extract the most important dimensions or first K principal components. It is noted that the operations 606-612 can be performed in a different order or be performed substantially simultaneously.

In operation 614, the training component 220 trains the ML model. In example embodiments, the training component 220 receives the labeled data from the data label component 212. In some embodiments, the training component 220 can also receive one or more of the normalized numerical data from normalizer 214, the encoded categorical data from the encoder 116, or the transformed text data from the transformer component 218. The training component 220 uses the data it receives to train the ML model. In one embodiment, the training component 220 comprise a Extreme Gradient Boost (XGBoost). In alternative embodiments, other gradient boosting components or machine learning models can be used (e.g., a decision tree).

In operation 616, the pipeline training system 112 stores the ML model for use by the inference service 302. In some embodiments, the ML model is stored to the model management system (MMS) 408.

In operation 618, the pipeline training system 112 obtains new data for new pipeline runs. In accordance with some embodiments, this new data can then be used to retrain the ML model by returning the method 600 to operation 604. In some embodiments, the retraining can be performed by the Krylov component 506 or a similar component that performs iterative methods.

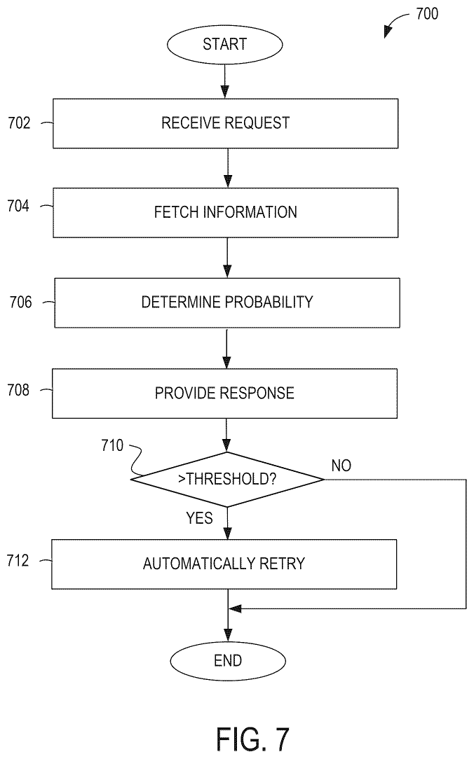

FIG. 7 is a flowchart of a method 700 for determining whether a pipeline failure occurred for a random reason of the infrastructure and triggering automated pipeline retry, according to example embodiments. Operations in the method 700 may be performed by the inference system 114 or the inference service 302 described above with respect to FIG. 1 and FIG. 3. Accordingly, the method 700 is described by way of example with reference to the inference service 302 (e.g., the inference system 114). However, it shall be appreciated that at least some of the operations of the method 700 may be deployed on various other hardware configurations or be performed by similar components residing elsewhere in the network environment 100. Therefore, the method 700 is not intended to be limited to the inference service 302.

In operation 702, a request indicating a new failed pipeline run is received from the frontend 402. In embodiments with the middleware 404, the middleware 404 receives the request. In embodiments without the middleware 404, the inference service 302 receives the request directly. The request can include an identifier of the new failed pipeline run.

In operation 704, information regarding the new failed pipeline run is fetched based on the identifier. In embodiments with the middleware 404, the middleware 404 calls the continuous delivery system API 406 for the information. The fetched information can include, for example, a duration of the pipeline run, which phase/stage the pipeline failed, and/or a failure time. The middleware 404 subsequently composes a request with the fetched information and sends it to the inference service 302. In embodiments without the middleware 404, the inference service 302 can obtain the information from the continuous delivery system 110 directly.

In operation 706, the inference service 302 performs a prediction for the pipeline run. In example embodiments, when the inference service 302 receives the request, the inference service 302 accesses the files and the ML model from the MMS 408 and uses the files and ML model to perform the prediction. The prediction can comprise a probability or score associated with whether the pipeline failure was a result of a random reason (e.g., a non-code issue or issue with the infrastructure).

In operation 708, the inference service 302 provides a response to the request. Thus, once the prediction is obtained, the inference service 302 sends the prediction back to the frontend 402 (through the middleware 404 if present). In some cases, the prediction comprises an indication of whether the pipeline run failure was likely a result of a random reason (e.g., should be retried; yes) or a result of a code issue (e.g., should not be retried; no). In some cases, the response can include the probability or score.

In operation 710, a determination is made whether the probability (or score) transgress a threshold. If the probability does not transgress the threshold, then the method 700 ends. However, if the probability does transgress the threshold (e.g., is greater than 0.5), then a pipeline run retry is automatically triggered in operation 712.

In some embodiments, the inference service 302 keeps track of how the continuous delivery system 110 or pipeline is performing. Instead of or in addition to returning the response, the inference service 302 can automatically trigger generation of reports regarding continuous delivery system 110 or pipeline performance to be sent to a user.

In various embodiments, there can be true positives, true negatives, and false positives. A true positive occurs when a new failed pipeline run is identified as should retry and the failure was for a random reason such as a platform issue causing an application to fail to start up or other non-code issues. Properly identifying a true positive will save on developer time to investigate and save on computational resources needed to perform the investigation.

A true negative occurs when a new failed pipeline run is identified as being not based on a random reason (e.g., should not be retried but investigated). By properly identifying a true negative, extra (and pointless) retries are avoided thus decreasing lead time and saving on computing resources that would have been otherwise wasted performing the retries.

A false positive occurs when a new failed pipeline run is identified as should retry but did not fail because of a random reason. This can occur because, for example, a startup timeout message was received but a review of a deployment log indicates there was an exception caused by a code change. In a further embodiment, historical deployment logs can be used as training data to train the ML model to detect these occurrences.

FIG. 8 illustrates components of a machine 800, according to some example implementations, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 8 shows a diagrammatic representation of the machine 800 in the example form of a computer device (e.g., a computer) and within which instructions 824 (e.g., software, a program, an application, an applet, an app, or other executable code) for causing the machine 800 to perform any one or more of the methodologies discussed herein may be executed, in whole or in part.

For example, the instructions 824 may cause the machine 800 to execute the flow diagram of FIG. 3 to FIG. 7. In one implementation, the instructions 824 can transform the machine 800 into a particular machine (e.g., specially configured machine) programmed to carry out the described and illustrated functions in the manner described.

In alternative implementations, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824 (sequentially or otherwise) that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more components described herein.

The machine 800 may further include a graphics display 810 (e.g., a plasma display panel (PDP), a light emitting diode (LED) display, a liquid crystal display (LCD), a projector, or a cathode ray tube (CRT), or any other display capable of displaying graphics or video). The machine 800 may also include an input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a sound card, an amplifier, a speaker, a headphone jack, or any suitable combination thereof), and a network interface device 820.

The storage unit 816 includes a machine-storage medium 822 (e.g., a tangible machine-storage medium) on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, before or during execution thereof by the machine 800. Accordingly, the main memory 804 and the processor 802 may be considered as machine-storage media (e.g., tangible and non-transitory machine-storage media). The instructions 824 may be transmitted or received over a network 826 via the network interface device 820.

In some example implementations, the machine 800 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 804, 806, and/or memory of the processor(s) 802) and/or storage unit 816 may store one or more sets of instructions and data structures (e.g., software) 824 embodying or utilized by any one or more of the methodologies or functions described herein. These instructions, when executed by processor(s) 802 cause various operations to implement the disclosed implementations.

As used herein, the terms “machine-storage medium,” “device-storage medium,” “computer-storage medium” (referred to collectively as “machine-storage medium 822”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 822 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 822 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 824 may further be transmitted or received over a communications network 826 using a transmission medium via the network interface device 820 and utilizing any one of a number of well-known transfer protocols (e.g., HTTP). Examples of communication networks 826 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some implementations, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example implementations, the one or more processors or processor-implemented components may be located in a single geographic location (e.g., within a home environment, an office environment, or a server farm). In other example implementations, the one or more processors or processor-implemented components may be distributed across a number of geographic locations.

### EXAMPLES

Described implementations of the subject matter can include one or more features, alone or in combination, as illustrated below by way of example.

Example 1 is a method for providing machine learning (ML) automated pipeline failure determination. The method comprises grouping previous pipeline runs into a dataset by corresponding identifiers; processing the dataset through a training pipeline, the processing comprising labeling, using an automated labeling algorithm, failed pipeline runs in the dataset with either an indication to retry or an indication not to retry, the indication to retry being associated with a failure based on an infrastructure issue or a random reason; training a machine learning (ML) model with training data from the processed dataset; receiving a request comprising information regarding a new failed pipeline run; determining a probability of the new failed pipeline run being caused by an infrastructure issue or a random reason by applying the information to the ML model; and based on the probability transgressing a threshold, automatically triggering a retry of the new failed pipeline run.

In example 2, the subject matter of example 1 can optionally include wherein the labeling comprises initially labeling all failed pipeline runs with the indication to not retry by default; and relabeling failed pipeline runs in which a final run is a success without any human intervention with the indication to retry.

In example 3, the subject matter of any of examples 1-2 can optionally include wherein the labeling comprises initially labeling all failed pipeline runs with the indication to not retry by default; and relabeling, without human intervention, failed pipeline runs in which failure was not based on a code change with the indication to retry.

In example 4, the subject matter of any of examples 1-3 can optionally include wherein the processing further comprises extracting numerical data from the dataset; and normalizing the numerical data, wherein the training data includes the normalized numerical data.

In example 5, the subject matter of any of examples 1-4 can optionally include wherein the processing further comprises extracting categorical data from the dataset; and encoding the categorical data, wherein the training data includes the encoded categorical data.

In example 6, the subject matter of any of examples 1-5 can optionally include wherein the processing further comprises extracting text data from the dataset; converting the text data into an embedding; and using principal component analysis, extracting first k principal components from the embedding, wherein the training data includes the first k principal components.

In example 7, the subject matter of any of examples 1-6 can optionally include wherein the processed dataset comprises validation data, and the method further comprises tuning parameters of the ML model using the validation data.

In example 8, the subject matter of any of examples 1-7 can optionally include wherein the processed dataset comprises test data, and the method further comprises testing an accuracy of the ML model by applying the test data to the ML model to obtain a prediction; and comparing the prediction with labels given to the test data.

In example 9, the subject matter of any of examples 1-8 can optionally include fetching a new dataset of pipeline runs; and retraining the ML model using the new dataset.

In example 10, the subject matter of any of examples 1-9 can optionally include wherein the indication not to retry comprises an indication of a code issue causing a failure of a corresponding pipeline run.

In example 11, the subject matter of any of examples 1-10 can optionally include wherein the indication to retry comprises an indication of an infrastructure issue or a random reason causing a failure of a corresponding pipeline run.

Example 12 is a system for providing machine learning (ML) automated pipeline failure determination. The system comprises one or more processors and a memory storing instructions that, when executed by the one or more processors, cause the one or more processors to perform operations comprising grouping previous pipeline runs into a dataset by corresponding identifiers; processing the dataset through a training pipeline, the processing comprising labeling, using an automated labeling algorithm, failed pipeline runs in the dataset with either an indication to retry or an indication not to retry, the indication to retry being associated with a failure based on an infrastructure issue or a random reason; training a machine learning (ML) model with training data from the processed dataset; receiving a request comprising information regarding a new failed pipeline run; determining a probability of the new failed pipeline run being caused by an infrastructure issue or a random reason by applying the information to the ML model; and based on the probability transgressing a threshold, automatically triggering a retry of the new failed pipeline run.

In example 13, the subject matter of example 12 can optionally include wherein the labeling comprises initially labeling all failed pipeline runs with the indication to not retry by default; and relabeling failed pipeline runs in which a final run is a success without any human intervention with the indication to retry.

In example 14, the subject matter of any of examples 12-13 can optionally include wherein the labeling comprises initially labeling all failed pipeline runs with the indication to not retry by default; and relabeling, without human intervention, failed pipeline runs in which failure was not based on a code change with the indication to retry.

In example 15, the subject matter of any of examples 12-14 can optionally include wherein the processing further comprises extracting numerical data from the dataset; and normalizing the numerical data, wherein the training data includes the normalized numerical data.

In example 16, the subject matter of any of examples 12-15 can optionally include wherein the processing further comprises extracting categorical data from the dataset; and encoding the categorical data, wherein the training data includes the encoded categorical data.

In example 17, the subject matter of any of examples 12-16 can optionally include wherein the processing further comprises extracting text data from the dataset; converting the text data into an embedding; and using principal component analysis, extracting first k principal components from the embedding, wherein the training data includes the first k principal components.

In example 18, the subject matter of any of examples 12-17 can optionally include wherein the processed dataset comprises validation data, and the method further comprises tuning parameters of the ML model using the validation data.

In example 19, the subject matter of any of examples 12-18 can optionally include wherein the processed dataset comprises test data, and the method further comprises testing an accuracy of the ML model by applying the test data to the ML model to obtain a prediction; and comparing the prediction with labels given to the test data.

Example 20 is a machine-storage medium comprising instructions which, when executed by one or more processors of a machine, cause the machine to perform operations for providing machine learning (ML) automated pipeline failure determination. The operations comprise grouping previous pipeline runs into a dataset by corresponding identifiers; processing the dataset through a training pipeline, the processing comprising labeling, using an automated labeling algorithm, failed pipeline runs in the dataset with either an indication to retry or an indication not to retry, the indication to retry being associated with a failure based on an infrastructure issue or a random reason; training a machine learning (ML) model with training data from the processed dataset; receiving a request comprising information regarding a new failed pipeline run; determining a probability of the new failed pipeline run being caused by an infrastructure issue or a random reason by applying the information to the ML model; and based on the probability transgressing a threshold, automatically triggering a retry of the new failed pipeline run.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method comprising:
grouping previous pipeline runs into a dataset by corresponding identifiers;
processing the dataset through a training pipeline, the processing comprising labeling, using an automated labeling algorithm, failed pipeline runs in the dataset with either an indication to retry or an indication not to retry, the indication to retry being associated with a failure based on an infrastructure issue or a random reason;
training a machine learning (ML) model with training data from the processed dataset;
receiving a request comprising information regarding a new failed pipeline run;
determining a probability of the new failed pipeline run being caused by an infrastructure issue or a random reason by applying the information to the ML model; and
based on the probability transgressing a threshold, automatically triggering a retry of the new failed pipeline run.

2. The method of claim 1, wherein the labeling comprises:
initially labeling all failed pipeline runs with the indication to not retry by default; and
relabeling failed pipeline runs in which a final run is a success without any human intervention with the indication to retry.

3. The method of claim 1, wherein the labeling comprises:
initially labeling all failed pipeline runs with the indication to not retry by default; and
relabeling, without human intervention, failed pipeline runs in which failure was not based on a code change with the indication to retry.

4. The method of claim 1, wherein the processing further comprises:
extracting numerical data from the dataset; and
normalizing the numerical data, wherein the training data includes the normalized numerical data.

5. The method of claim 1, wherein the processing further comprises:
extracting categorical data from the dataset; and
encoding the categorical data, wherein the training data includes the encoded categorical data.

6. The method of claim 1, wherein the processing further comprises:
extracting text data from the dataset;
converting the text data into an embedding; and
using principal component analysis, extracting first k principal components from the embedding, wherein the training data includes the first k principal components.

7. The method of claim 1, wherein the processed dataset comprises validation data, and the method further comprises tuning parameters of the ML model using the validation data.

8. The method of claim 1, wherein the processed dataset comprises test data, and the method further comprises testing an accuracy of the ML model by:
applying the test data to the ML model to obtain a prediction; and
comparing the prediction with labels given to the test data.

9. The method of claim 1, further comprising:
fetching a new dataset of pipeline runs; and
retraining the ML model using the new dataset.

10. The method of claim 1, wherein the indication not to retry comprises an indication of a code issue causing a failure of a corresponding pipeline run.

11. The method of claim 1, wherein the indication to retry comprises an indication of an infrastructure issue or a random reason causing a failure of a corresponding pipeline run.

12. A system comprising:
one or more processors; and
a memory storing instructions that, when executed by the one or more processors, cause the one or more processors to perform operations comprising:
grouping previous pipeline runs into a dataset by corresponding identifiers;
processing the dataset through a training pipeline, the processing comprising labeling, using an automated labeling algorithm, failed pipeline runs in the dataset with either an indication to retry or an indication not to retry, the indication to retry being associated with a failure based on an infrastructure issue or a random reason;
training a machine learning (ML) model with training data from the processed dataset;
receiving a request comprising information regarding a new failed pipeline run;
determining a probability of the new failed pipeline run being caused by an infrastructure issue or a random reason by applying the information to the ML model; and
based on the probability transgressing a threshold, automatically triggering a retry of the new failed pipeline run.

13. The system of claim 12, wherein the labeling comprises:
initially labeling all failed pipeline runs with the indication to not retry by default; and
relabeling failed pipeline runs in which a final run is a success without any human intervention with the indication to retry.

14. The system of claim 12, wherein the labeling comprises:
initially labeling all failed pipeline runs with the indication to not retry by default; and
relabeling, without human intervention, failed pipeline runs in which failure was not based on a code change with the indication to retry.

15. The system of claim 12, wherein the processing further comprises:
extracting numerical data from the dataset; and
normalizing the numerical data, wherein the training data includes the normalized numerical data.

16. The system of claim 12, wherein the processing further comprises:
extracting categorical data from the dataset; and
encoding the categorical data, wherein the training data includes the encoded categorical data.

17. The system of claim 12, wherein the processing further comprises:
extracting text data from the dataset;
converting the text data into an embedding; and
using principal component analysis, extracting first k principal components from the embedding, wherein the training data includes the first k principal components.

18. The system of claim 12, wherein the processed dataset comprises validation data, and the method further comprises tuning parameters of the ML model using the validation data.

19. The system of claim 12, wherein the processed dataset comprises test data, and the method further comprises testing an accuracy of the ML model by:
applying the test data to the ML model to obtain a prediction; and
comparing the prediction with labels given to the test data.

20. A machine-storage medium comprising instructions which, when executed by one or more processors of a machine, cause the machine to perform operations comprising:
grouping previous pipeline runs into a dataset by corresponding identifiers;
processing the dataset through a training pipeline, the processing comprising labeling, using an automated labeling algorithm, failed pipeline runs in the dataset with either an indication to retry or an indication not to retry, the indication to retry being associated with a failure based on an infrastructure issue or a random reason;
training a machine learning (ML) model with training data from the processed dataset;
receiving a request comprising information regarding a new failed pipeline run;
determining a probability of the new failed pipeline run being caused by an infrastructure issue or a random reason by applying the information to the ML model; and
based on the probability transgressing a threshold, automatically triggering a retry of the new failed pipeline run.
